(19) United States
(12) Patent Application Publication
(10) Pub. No.: US 2011/0116678 A1
(43) Pub. Date: May 19, 2011

(54) Speaker having a long voice coil bobbin and dampers

(76) Inventor: Chao-Lang Wang, Xizhi City (TW)

(21) Appl. No.: 12/662,901

(22) Filed: May 11, 2010

(30) Foreign Application Priority Data
Nov. 19, 2009 (TW) 098139273

(51) Int. Cl. H04R 9/06

(52) U.S. Cl. 381/407

(57) ABSTRACT

The present invention is to provide a speaker having a long voice coil bobbin and a plurality of dampers, wherein each of the dampers is formed with a central hole for connecting to the long voice coil bobbin at a position adjacent to a lower or upper end of a cone frame of the speaker for enabling the long voice coil bobbin to stably vibrate due to the balance effect of the dampers. In addition, since a ratio of 3˜6 is defined between the length of the long voice coil bobbin and winding length of a voice coil unit of the speaker, the long voice coil bobbin is able to perform the true frequency and amplitude of mega bass more precisely and transmit the vibration to a diaphragm of the speaker for enhancing the vibration strength of the diaphragm and improving the sound quality and volume of the speaker effectively.

### FIELD OF THE INVENTION

The present invention relates to a speaker, more particularly to a speaker having a long voice coil bobbin and a plurality of dampers, wherein a first damper and a second damper made of corrugated damping membranes are formed with a central hole respectively for connecting to the long voice coil bobbin at a position adjacent to a lower or upper surface of a cone frame of the speaker, so as to enable the long voice coil bobbin to stably and reciprocally vibrate in the speaker due to the balance effect of the first and second dampers. In addition, since a better ratio is defined between the length of the long voice coil bobbin and winding length of a voice coil unit of the speaker, the weight of the long voice coil bobbin is greater than that of the voice coil bobbin of a traditional speaker having the same power, so as to enable the long voice coil bobbin to perform the true frequency and amplitude of mega bass more precisely and to transmit the vibration to a diaphragm of the speaker for enhancing the vibration strength of the diaphragm and the sound quality and volume of the speaker.

### BACKGROUND OF THE INVENTION

Generally, a consumer electronic product (such as a mobile phone, a navigation device, a speaker, an audio device, a walkman, a handheld game console or the like) is provided with at least one speaker for playing sounds including music or voices. Recently, with the development of electronic technologies, various consumer electronic products are rapidly developed and improved to meet the trend of compactness and miniaturization. Therefore, each of the consumer electronic products only can be provided with a speaker with smaller size, such that the sound volume played by the speaker is apparently lower. Especially, the speaker can not provide outstanding performance in the portion of low frequencies. As a result, when a user uses such a consumer electronic products to play sounds, the user can not hear clear and resonant sounds, and can not fully enjoy the powerful bass efficiency of the speaker.

Referring now to FIG. 1, a traditional speaker structure 10 is illustrated. As shown, the traditional speaker structure 10 comprises a frame body 11, a metal gasket 16, an annular magnet 12, a voice coil bobbin 13, a damper 14, a diaphragm 15 and a T-shape yoke 17, wherein the frame body 11 is formed with a receiving space 111 therein. A central position of a lower surface of the frame body 11 is formed with a first through hole 112, while a central position of an upper surface of the metal gasket 16 is formed with a second through hole 161. The upper surface of the metal gasket 16 is attached to the lower surface of the frame body 11, so that the second through hole 161 can be communicated with the first through hole 112. A central position of an upper surface of the annular magnet 12 is formed with a third through hole 121, and the upper surface of the annular magnet 12 is attached to a lower surface of the metal gasket 16, so that the third through hole 121 can be communicated with the second through hole 161. A first end of the voice coil bobbin 13 is wound with a voice coil unit 131, and the length of the voice coil bobbin 13 is twice (generally, 2 to 2.5 times) as long as the winding length of the voice coil unit 131. The first end of the voice coil bobbin 13 and the voice coil unit 131 thereon pass through the first through hole 112 and the second through hole 161, and received in the third through hole 121 of the annular magnet 12. Thus, the annular magnet 12 surrounds the first end of the voice coil bobbin 13 and the voice coil unit 131 thereon, while a second end of the voice coil bobbin 13 is received in the receiving space 111 of the frame body 11. The damper 14 is a concentric corrugated membrane sleeved on the second end of the voice coil bobbin 13. An outer edge of the damper 14 is horizontally connected to an inner periphery of the frame body 11. The diaphragm 15 is attached to an inner periphery of one side end of the frame body 11, and extended toward the receiving space 111, wherein a central position of the diaphragm 15 is connected to the second end of the voice coil bobbin 13. The T-shape yoke 17 is made of metal material, and a central position of an upper surface of the T-shape yoke 17 is extended upward to form a pole 171, wherein the upper surface of the T-shape yoke 17 is attached to a lower surface of the annular magnet 12, so that the pole 171 can insert into an inner space of one end of the voice coil bobbin 13. Therefore, when an electric current passes through the voice coil unit 131, the voice coil unit 131 will be energized to generate an electromagnetic effect, wherein magnetic lines of forces generated by the voice coil unit 131 as well as the annular magnet 12, the metal gasket 16 and the T-shape yoke 17 surrounding the voice coil unit 131 can commonly generate attractive and repulsive forces. Therefore, according to variation of the strength and direction of the electric current of sound signals inputted into the voice coil unit 131, the voice coil bobbin 13 wound with the voice coil unit 131 will reciprocally vibrate. As a result, the diaphragm 15 will simultaneously vibrate corresponding to the vibration of the voice coil bobbin 13, so that the traditional speaker structure 10 can generate sounds.

However, in the traditional speaker structure 10, because the length of the voice coil bobbin 13 is only 2 to 2.5 times of the winding length of the voice coil unit 131 wound on the voice coil bobbin 13, the length of the voice coil bobbin 13 is too short and the weight thereof is too light. Thus, when the voice coil unit 131 is energized to generate the attractive and repulsive forces between the voice coil unit 131 and the annular magnet 12, the voice coil bobbin 13 wound with the voice coil unit 131 reacts against the attractive and repulsive forces too sensitively and rapidly due to insufficient length and weight of the voice coil bobbin 13. As a result, the voice coil bobbin 13 can not fully transmit vibrations to the diaphragm 15, so that the vibration strength of the diaphragm 15 is insufficient. It may cause that the bass strength generated by the traditional speaker structure 10 is relatively low, resulting in losing the sound quality. Thus, the traditional speaker structure 10 can not perform true bass effect.

Furthermore, since the cross-sectional angle between the reciprocal vibration pathway of the voice coil bobbin 13 of the traditional speaker structure 10 and the frame body 11 (i.e. an inclination angle of an outer periphery of the frame body 11) is too large, the impact force generated due to the reciprocal vibration of the voice coil bobbin 13 can not be efficiently buffered. Meanwhile, the counterforce generated due to the impact force causes the annular magnet 12, the metal gasket 16 and the T-shape yoke 17 mounted below the frame body 11 to transiently move toward a reverse direction, so that the partial vibration strength of the diaphragm 15 will be neutralized. In addition, the annular magnet 12, the metal gasket 16 and the T-shape yoke 17 of the traditional speaker structure 10 are used to provide the kinetic energy for the reciprocal vibration of the voice coil bobbin 13. Thus, when the voice coil bobbin 13 wound with the voice coil unit 131 generates the reciprocal vibration according to the variation of the electric current inputted into the voice coil unit 131 to cause the simultaneous vibration of the diaphragm 15 with the voice coil bobbin 13, the voice coil bobbin 13 and the diaphragm 15 will generate the impact force to the frame body 11 due to the reciprocal vibration, and the frame body 11 can not fully buffer the impact force generated by the reciprocal vibration of the voice coil bobbin 13 and the diaphragm 15 due to the cross-sectional angle of the frame body 11 and the included angle of the reciprocally linear vibration pathway of the voice coil bobbin 13 are too large angles. As a result, the frame body 11 is easily affected by the impact force to generate a resonance effect, so as to neutralize the partial vibration strength of the diaphragm 15, resulting in the distortion of the sound quality generated by the traditional speaker structure 10.

As a result, it is important for the inventor to think how to develop an innovative speaker to solve the foregoing problems existing in the traditional speaker structure by increasing the length of a long voice coil bobbin in the speaker to provide a better ratio between the length of the long voice coil bobbin and the winding length of a voice coil unit thereon and to extend the frequency range and amplitude of the long voice coil bobbin, so as to increase the vibration strength of a diaphragm of the speaker and carry out the extension effect of the frequency range of the speaker, for the purpose of enhancing the sound quality of the speaker.

It is therefore tried by the inventor to develop a speaker having a long voice coil bobbin and a plurality of dampers, so that a user can enjoy clearer sounds and best bass effect when the user listens to sounds played by the speaker.

### BRIEF SUMMARY OF THE INVENTION

An object of the present invention is to provide a speaker having a long voice coil bobbin and a plurality of dampers, wherein the speaker comprises a cone frame, a magnetic element (such as an assembly of a magnet and a yoke), a long voice coil bobbin, a first damper, a second damper and a diaphragm. The cone frame is made of a one-piece metal plate formed by punching or casting, and an upper surface of the cone frame is formed with an opening. A receiving space is defined in the cone frame, and a central position of a lower surface of the cone frame is formed with a through hole. A central position of an upper surface of the magnetic element is provided with a receiving recess, and the upper surface of the magnetic element is attached to the lower surface of the cone frame, so that the receiving recess is communicated with the through hole. The long voice coil bobbin is a hollow tube, wherein a first end thereof is wound with a voice coil unit which is at least one metal wire wound on the first end of the long voice coil bobbin by a predetermined manner. The length of the long voice coil bobbin is at least 3 to 6 times of the winding length of the voice coil unit, while the outer diameter of the long voice coil bobbin and the voice coil unit is slightly smaller than the inner diameter of the through hole and the receiving recess. Thus, the first end of the long voice coil bobbin and the voice coil unit wound thereon can pass through the through hole and extend downward out of the cone frame for inserting into the receiving recess of the magnetic element, while a second end of the long voice coil bobbin is received in the receiving space of the cone frame. The first damper and the second damper are concentric corrugated damping membranes, each of which is formed with a central hole. An inner edge of the central hole of the first damper is sleeved and mounted on a position of the long voice coil bobbin adjacent to the lower surface of the cone frame, while an inner edge of the central hole of the second damper is sleeved and mounted on a position of the long voice coil bobbin adjacent to the upper surface of the cone frame. Outer edges of the first and second dampers are horizontally connected to an inner periphery of the cone frame. The diaphragm is attached to an inner edge of the opening of the cone frame, and extended toward the receiving space, wherein a central portion of the diaphragm is connected to the second end of the long voice coil bobbin. Therefore, when an electric current passes through the voice coil unit on the first end of the long voice coil bobbin to energize the voice coil unit, the voice coil unit will generate magnetic lines of force, wherein the magnetic lines of force generated by the voice coil unit and magnetic lines of force generated by the magnetic element can commonly generate attractive and repulsive forces, so as to actuate the long voice coil bobbin to reciprocally vibrate and to cause the diaphragm to simultaneously vibrate corresponding to the vibration of the long voice coil bobbin for oscillating the ambient air in front of the speaker to generate sounds. Meanwhile, the long voice coil bobbin will stably and reciprocally vibrate in the through hole on the lower surface of the cone frame based on the balance effect of the first and second dampers. Because the maximum length of the voice coil bobbin of the traditional speaker is only 2.5 times of the winding length of the voice coil unit wound thereon, the weight of the voice coil bobbin is insufficient. Therefore, when the voice coil unit of the traditional speaker is energized to generate the attractive and repulsive forces between the voice coil unit and the magnetic element, the voice coil bobbin reacts against the attractive and repulsive forces too sensitively and rapidly due to the insufficient weight of the voice coil bobbin. As a result, it may cause that the bass strength generated by the traditional speaker structure is relatively low to cause the loss of the sound quality, so that the traditional speaker structure can not perform true bass effect. Because the speaker of the present invention has the long voice coil bobbin and a better ratio is defined between the length of the long voice coil bobbin and the winding length of the voice coil unit, the weight of the long voice coil bobbin in the speaker of the present invention is greater than that of the voice coil bobbin of the traditional speaker having the same power. Therefore, when the long voice coil bobbin in the speaker of the present invention is actuated to reciprocally vibrate by the attractive and repulsive forces generated between the voice coil unit and the magnetic element, the reaction time of the long voice coil bobbin reacting against the attractive and repulsive forces is several milliseconds slower than that of the voice coil bobbin of the traditional speaker. As a result, the long voice coil bobbin can perform the true frequency and amplitude of mega bass more precisely, and the vibration can be transmitted to the diaphragm, so that the vibration strength of the diaphragm is sufficient to oscillate the ambient air to perform the true mega bass effect, for the purpose of substantially enhancing the sound quality and volume of the speaker of the present invention.

### BRIEF DESCRIPTION OF THE SEVERAL VIEWS OF THE DRAWINGS

The structure and the technical means adopted by the present invention to achieve the above and other objects can be best understood by referring to the following detailed description of the preferred embodiments and the accompanying drawings, wherein

FIG. 1 is a cross-sectional view of a traditional speaker structure;

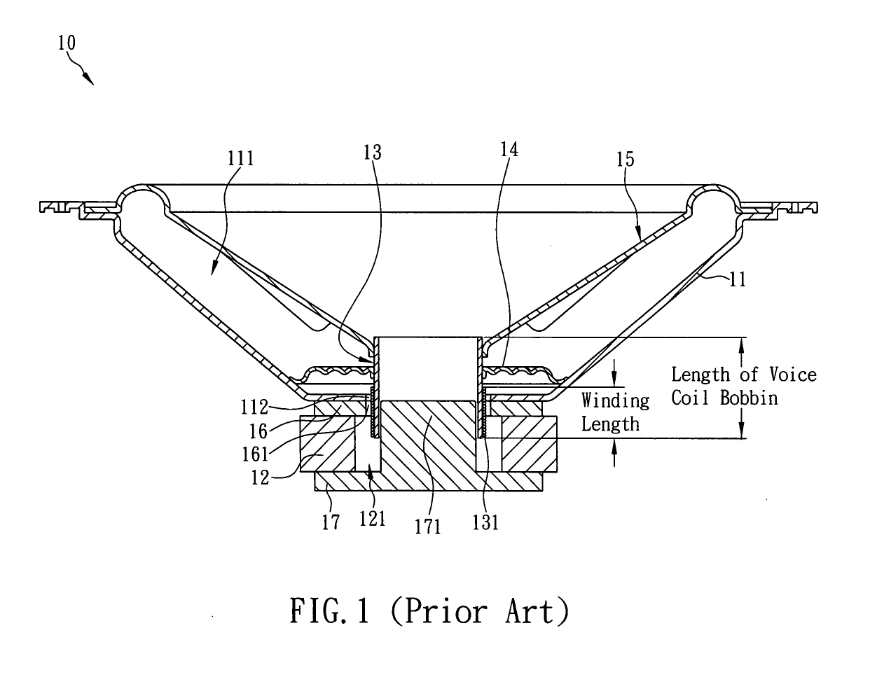

FIG. 2 is an exploded perspective view of a speaker having a long voice coil bobbin and a plurality of dampers according to a preferred embodiment of the present invention; and

FIG. 3 is an assembled cross-sectional view of the speaker having a long voice coil bobbin and a plurality of dampers according to the preferred embodiment of the present invention.

### DETAILED DESCRIPTION OF THE INVENTION

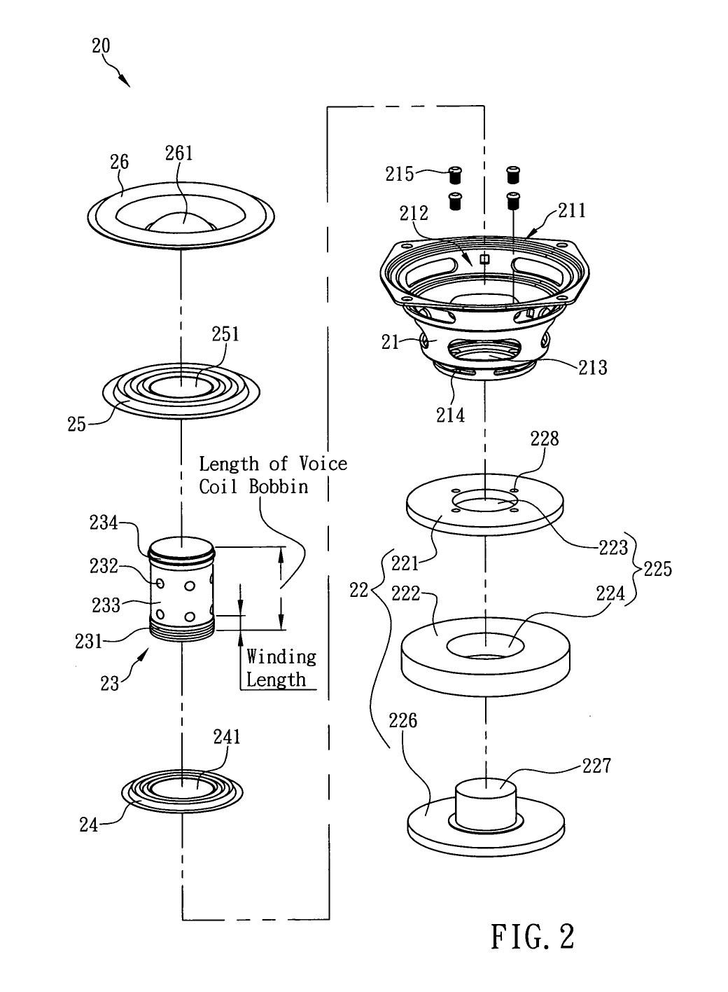

The present invention is a speaker having a long voice coil bobbin and a plurality of dampers. Referring now to FIG. 2, in a preferred embodiment of the present invention, a speaker 20 comprises a cone frame 21, a magnetic element 22, a long voice coil bobbin 23, a first damper 24, a second damper 25 and a diaphragm 26, wherein the cone frame 21 is made of a one-piece metal plate formed by punching or casting. An upper surface of the cone frame 21 is formed with an opening 211, and a receiving space 212 is defined in the cone frame 21, while a central position of a lower surface of the cone frame 21 is formed with a through hole 213.

As describe above, the magnetic element 22 comprises a first yoke 221, an annular magnet 222 and a second yoke 226, wherein the first yoke 221 is made of metal material, such as iron, and a central position of an upper surface of the first yoke 221 is formed with a first receiving hole 223. The upper surface of the first yoke 221 is attached to the lower surface of the cone frame 21, so that the first receiving hole 223 of the first yoke 221 is communicated with the through hole 213 of the cone frame 21. A central position of an upper surface of the annular magnet 222 is formed with a second receiving hole 224, and the upper surface of the annular magnet 222 is attached to a lower surface of the first yoke 221, so that the second receiving hole 224 of the annular magnet 222 is communicated with the first receiving hole 223 of the first yoke 221. Thus, a receiving recess 225 is defined between the second receiving hole 224 and the first receiving hole 223, while the receiving recess 225 is communicated with the through hole 213. The second yoke 226 is made of metal material, such as iron, and a central position of an upper surface of the second yoke 226 is formed with a central pole 227 (i.e. central post) made of metal material, so that the cross section of the second yoke 226 is T-shape. The outer diameter of the central pole 227 is slightly smaller than the inner diameter of the long voice coil bobbin 23 and the inner diameter of the receiving recess 225. The upper surface of the second yoke 226 is attached to a lower surface of the annular magnet 222, while the central pole 227 can pass through the receiving recess 225 and insert into the one end of the long voice coil bobbin 23.

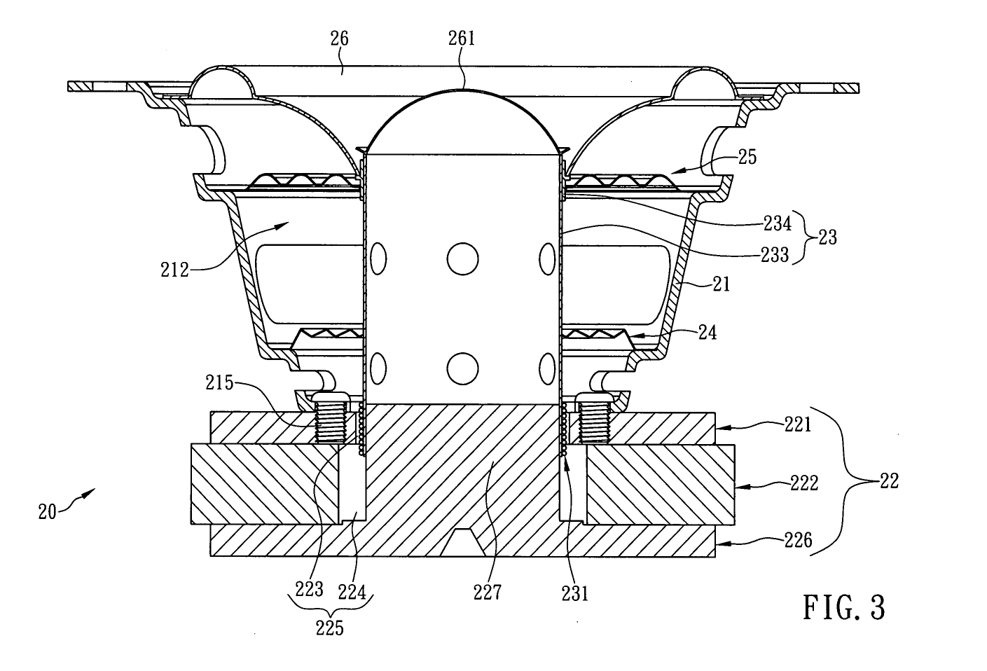

Referring now to FIGS. 2 and 3, the long voice coil bobbin 23 is a hollow tube, wherein the aforesaid end of the long voice coil bobbin 23, also referred to as the first end, is peripherally wound with a voice coil unit 231 which is at least one metal wire wound on the first end of the long voice coil bobbin 23 by a predetermined manner. The length of the long voice coil bobbin 23 is at least 3 to 6 times of the winding length of the voice coil unit 231, while the outer diameter of the long voice coil bobbin 23 and the outer diameter of the voice coil unit 231 are slightly smaller than the inner diameter of the through hole 213 and the inner diameter of the receiving recess 225 (i.e. the first receiving hole 223 and the second receiving hole 224). Thus, the first end of the long voice coil bobbin 23 and the voice coil unit 231 wound thereon can pass through the through hole 213 and extend downward out of the cone frame 21 for inserting into a peripheral space around the central pole 227 of the second yoke 226 and being received in the receiving recess 225 of the magnetic element 22, while a second end of the long voice coil bobbin 23 opposite to the first end is received in the receiving space 212 of the cone frame 21.

As described above, the first damper 24 and the second damper 25 are concentric corrugated damping membranes, wherein the first damper 24 is formed with a first central hole 241, and the second damper 25 is formed with a second central hole 251. An inner edge of the first central hole 241 of the first damper 24 is sleeved and mounted on a position of the long voice coil bobbin 23 adjacent to the lower surface of the cone frame 21, while an inner edge of the second central hole 251 of the second damper 25 is sleeved and mounted on a position of the long voice coil bobbin 23 adjacent to the upper surface of the cone frame 21. Outer edges of the first damper 24 and second damper 25 are horizontally connected to an inner periphery of the cone frame 21. Furthermore, the diaphragm 26 is attached to an inner edge of the opening 211 of the cone frame 21, and extended toward the receiving space 212, wherein a central portion of the diaphragm 26 is connected to the second end of the long voice coil bobbin 23.

Therefore, when an electric current passes through the voice coil unit 231 on the first end of the long voice coil bobbin 23 to energize the voice coil unit 231, the voice coil unit 231 will generate magnetic lines of force, wherein the magnetic lines of force generated by the voice coil unit 231 and magnetic lines of force generated by the magnetic element 22 can commonly generate attractive and repulsive forces, so as to actuate the long voice coil bobbin 23 to reciprocally vibrate and to cause the diaphragm 26 to simultaneously vibrate corresponding to the vibration of the long voice coil bobbin 23 for oscillating the ambient air in front of the speaker 20 to generate sounds. Meanwhile, the long voice coil bobbin 23 will stably and reciprocally vibrate in the through hole 213 on the lower surface of the cone frame 21 based on the balance effect of the first and second dampers 24, 25. Because the speaker 20 of the present invention has the long voice coil bobbin 23 and a better ratio is defined between the length of the long voice coil bobbin 23 and the winding length of the voice coil unit 231 (the length of the long voice coil bobbin 23 is at least 3 to 6 times of the winding length of the voice coil unit 231), the weight of the long voice coil bobbin 23 in the speaker 20 of the present invention is greater than that of the voice coil bobbin of the traditional speaker having the same power. Therefore, when the long voice coil bobbin 23 in the speaker 20 of the present invention is actuated to reciprocally vibrate by the attractive and repulsive forces generated between the voice coil unit 231 and the magnetic element 22, the reaction time of the long voice coil bobbin 23 reacting against the attractive and repulsive forces is several milliseconds slower than that of the voice coil bobbin of the traditional speaker. As a result, the long voice coil bobbin 23 can extend the ranges of frequency and amplitude, and transmit vibrations to the diaphragm 26, so that the vibration strength of the diaphragm 26 is sufficient to oscillate the ambient air to increase the extension effect of frequency and amplitude. As a result, the sound quality of the speaker 20 of the present invention can be substantially enhanced, wherein the transmission speed and effect are based on the length, the weight, the material of the long voice coil bobbin 23 and the material, the weight and the winding length of the voice coil unit 231.

Referring to FIG. 2 again, in the preferred embodiment, the long voice coil bobbin 23 is further formed with a plurality of heat dissipating holes 232 thereon. In operation, the voice coil unit 231 on the long voice coil bobbin 23 will generate heat during the electric power passes through the resistance of the voice coil unit 231, and the heat will be transmitted to the speaker 20 via the long voice coil bobbin 23, resulting in raising the temperature of the speaker 20. Thus, the heat dissipating holes 232 can be used to increase the air circulation in the long voice coil bobbin 23 and the contact area between the long voice coil bobbin 23 and the ambient air. Meanwhile, the heat dissipation efficiency of the long voice coil bobbin 23 can be increased, so as to prevent the long voice coil bobbin 23 from be over-heated, aged or burned. The amount and the diameter of the heat dissipating holes 232 can be increased or reduced according to actual desire, wherein the heat dissipating holes 232 may be completely removed in some special cases.

Referring to FIG. 2 again, in the preferred embodiment, the lower surface of the cone frame 21 is radially and equidistantly formed with a plurality of first screw holes 214 close to an edge of the through hole 213, while the upper surface of the magnetic element 22 is formed with a plurality of second screw holes 228 corresponding to the first screw holes 214. Furthermore, the speaker 20 further comprises a plurality of fastening screws 215, each of which passes through the corresponding first and second screw holes 214, 228 in turn, so as to fasten the lower surface of the cone frame 21 to the upper surface of the magnetic element 22.

In addition, in the preferred embodiment, a central position of an upper surface of the diaphragm 26 is formed with a tweeter cap (i.e. a dust cap) 261 corresponding the second end of the long voice coil bobbin 23. The long voice coil bobbin 23 comprises an inner layer 233 and an outer layer 234. The inner layer 233 and the outer layer 234 are made of different material. For example, the material of the inner layer 233 of the long voice coil bobbin 23 can be ASV aluminum, metal material or composite material, wrapped material, etc., and the material of the outer layer 234 can be rubber, resin, etc. The friction coefficient of the surface of the inner layer 233 of the long voice coil bobbin 23 is smaller than that of the surface of the outer layer 234 of the long voice coil bobbin 23. Therefore, when the long voice coil bobbin 23 in the speaker 20 is actuated to reciprocally vibrate due to the attractive and repulsive forces generated between the voice coil unit 231 and the magnetic element 22, the flow speed of the air inside the long voice coil bobbin 23 is greater than that of the air outside the long voice coil bobbin 23 because the friction coefficient of the surface of the inner layer 233 of the long voice coil bobbin 23 is smaller than that of the surface of the outer layer 234 of the long voice coil bobbin 23. After this, the long voice coil bobbin 23 causes the air to impact the diaphragm 26 and the tweeter cap 261. Because the speed of the air of the surface of the inner layer 233 of the long voice coil bobbin 23 for impacting the tweeter cap 261 is several milliseconds faster than that of the air of the surface of the outer layer 234 of the long voice coil bobbin 23 for impacting the tweeter cap 261, the true frequency and amplitude of the midrange and tweeter can be precisely performed. As a result, not only the outer layer 234 of the long voice coil bobbin 23 of the speaker 20 can generate a bass effect more real than the traditional speaker structure, but also the inner layer 233 of the long voice coil bobbin 23 performs the true frequency and amplitude of the midrange and tweeter. Thus, various ranges of sounds generated by the speaker 20 can be more perfect than that of the traditional speaker structure.

Moreover, in other embodiments of the present invention, it should be noted that the first yoke 221, the annular magnet 222 and the second yoke 226 can be further received in the receiving space 212 of the cone frame 21, if necessary.

The present invention has been described with the preferred embodiments thereof and it is understood that many changes and modifications to the described embodiment can be carried out without departing from the scope and the spirit of the invention that is intended to be limited only by the appended claims.

What is claimed is:

1. A speaker having a long voice coil bobbin and a plurality of dampers, the speaker comprising:
a cone frame made of a one-piece metal plate formed by punching or casting, an upper surface of the cone frame being formed with an opening, and a receiving space being defined in the cone frame;
a magnetic element mounted to a lower surface of the cone frame, a central position of an upper surface of the magnetic element being provided with a receiving recess;
a long voice coil bobbin being a hollow tube, a first end thereof being wound with a voice coil unit which is at least one metal wire wound on the first end of the long voice coil bobbin by a predetermined manner, wherein a length of the long voice coil bobbin is at least 3 to 6 times of a winding length of the voice coil unit, while an outer diameter of the long voice coil bobbin with the voice coil unit is smaller than an inner diameter of the receiving recess, so that the first end of the long voice coil bobbin and the voice coil unit wound thereon are received in the receiving recess of the magnetic element, and a second end of the long voice coil bobbin opposite to the first end being received in the receiving space of the cone frame;
a first damper being concentric corrugated and formed with a first central hole, an inner edge of the central hole of the first damper being sleeved and mounted on a position of the long voice coil bobbin adjacent to the lower surface of the cone frame, and an outer edge of the first damper being horizontally connected to an inner periphery of the cone frame;
a second damper being concentric corrugated and formed with a second central hole, an inner edge of the central hole of the second damper being sleeved and mounted on a position of the long voice coil bobbin adjacent to the upper surface of the cone frame, and an outer edge of the second damper being horizontally connected to the inner periphery of the cone frame; and
a diaphragm attached to an inner edge of the opening of the cone frame, and extended toward the receiving space, wherein a central portion of the diaphragm is connected to the second end of the long voice coil bobbin.

2. The speaker according to claim 1, wherein the lower surface of the cone frame is formed with a through hole, an upper surface of the magnetic element is attached to the lower surface of the cone frame, so that the receiving recess is communicated with the through hole, and wherein the outer diameter of the long voice coil bobbin and the voice coil unit is smaller than an inner diameter of the through hole, so that the first end of the long voice coil bobbin and the voice coil unit wound thereon are allowed to pass through the through hole and extend out of the cone frame for inserting into the receiving recess of the magnetic element.

3. The speaker according to claim 2, wherein the magnetic element comprises a first yoke and an annular magnet, the first yoke being made of metal material, a central position of an upper surface of the first yoke being formed with a first receiving hole, and the upper surface of the first yoke being attached to the lower surface of the cone frame, so that the first receiving hole of the first yoke is communicated with the through hole of the cone frame, wherein a central position of an upper surface of the annular magnet is formed with a second receiving hole, and the upper surface of the annular magnet is attached to a lower surface of the first yoke, so that the second receiving hole of the annular magnet is communicated with the first receiving hole of the first yoke and the receiving recess is thus defined between the second receiving hole and the first receiving hole to be communicated with the through hole.

4. The speaker according to claim 3, wherein the magnetic element further comprises a second yoke made of metal material, and a central position of an upper surface of the second yoke is formed with a central pole made of metal material, so that a cross section of the second yoke is T-shape, wherein an outer diameter of the central pole is smaller than an inner diameter of the long voice coil bobbin and the receiving recess so that when the upper surface of the second yoke is attached to a lower surface of the annular magnet, the central pole is allowed to pass through the receiving recess and insert into the first end of the long voice coil bobbin.

5. The speaker according to claim 4, wherein the long voice coil bobbin comprises an inner layer and an outer layer, the inner layer and the outer layer being made of different material, and a friction coefficient of a surface of the inner layer of the long voice coil bobbin being smaller than that of a surface of the outer layer of the long voice coil bobbin.

6. The speaker according to claim 5, wherein a central position of an upper surface of the diaphragm is formed with a tweeter cap.

7. The speaker according to claim 6, wherein the long voice coil bobbin is further formed with a plurality of heat dissipating holes thereon.

8. The speaker according to claim 7, wherein the lower surface of the cone frame is radially and equidistantly formed with a plurality of first screw holes close to an edge of the through hole, and the upper surface of the magnetic element is formed with a plurality of second screw holes corresponding to the first screw holes, while the speaker further comprises a plurality of fastening screws, each of which passes through the corresponding first and second screw holes in turn, so as to fasten the lower surface of the cone frame to the upper surface of the magnetic element.
